(19) United States
(12) Patent Application Publication
(10) Pub. No.: US 2025/0327358 A1
(43) Pub. Date: Oct. 23, 2025

(54) PROTECTIVE FRAME FOR LARGE FRAMES

(71) Applicant: BBG, S.A., Esposende (PT)

(72) Inventors: Duarte João Alves Paulo, Caminha (PT); Miguel Sousa Araújo, Esposende (PT)

(21) Appl. No.: 19/175,044

(22) Filed: Apr. 10, 2025

(30) Foreign Application Priority Data
Apr. 19, 2024 (PT) 119417

(51) Int. Cl. E06B 9/24; E06B 9/52; G09F 7/18

(52) U.S. Cl. CPC E06B 9/24; E06B 9/52; G09F 7/18; E06B 2009/2417; E06B 2009/527; G09F 2007/1843; G09F 2007/1852

(57) ABSTRACT

The present invention relates to a protection frame for large frames, this protection frame aims to minimize pollution inside buildings through the placement of protective panels of specific types. The present invention comprises a perimeter frame (1) that surrounds a protective panel and has two parts: a magnetic part, which has embedded inside a plurality of magnetic means (2) and adheres by magnetism to the fixed frame of the window or door; and a non-magnetic part that incorporates the protective panel and is superimposed on the perimeter of vent, but does not contact it, avoiding damage. The perimeter frame (1) has fixing squares (3) located on the non-magnetic part, and alignment squares (5) located on the magnetic part, in this way the structure is reinforced and can thus increase the size of the job site rough opening/windows/doors.

### TECHNICAL FIELD

The present invention concerns a protective frame for large frames and falls within the area of frames, in particular frames for doors and windows and large dimensions, and even more in particular minimalist frames, in which the profiles are of dimensions reduced.

### BACKGROUND OF THE INVENTION

Increasingly, concern about eliminating pollution inside buildings is a current topic. Architects, builders, users want to eliminate pollution inside their homes, workplaces and buildings in general, which can come from a variety of sources, insects, light, dust, noise. With this goal in mind, a protection frame was developed for placement and application on windows and doors using magnetism. In particular, this protective frame is suitable for doors and windows with minimalist frames and large openings, which makes the solution of a different complexity and specific to this type of product.

The patent document US2023323733A1, discloses a solution of a magnetic frame, for application by magnetism to windows, in this case with the presence of a mosquito net. In this solution, the presence of magnetic elements is only in the corners of the frame, which for large spans is notoriously insufficient.

Patent document CN115324472A discloses a window protection that also uses magnets, and the protection is only referred to as an anti-mosquito effect. The use of magnets in this solution is along the perimeter frame and not just in the corners, however the corners of this protection are made of stainless steel, so they are firmer, which makes the structure heavy when we refer to frames with large spans. The magnetic elements are magnetic strips and magnetic profiles of the frame's fixed frame, which are fixed together. This type of magnetic tapes are suitable solutions for small weights and light structures, not for large frames, as the protection would give way. It should be noted that this solution implies that the frames are all manufactured together, the fixed frame has particularities so that the protection is functional in it.

### Technical Problems Solved and Advantages

The invention arises from the need to have the option of having a protective frame for large frames, for a sliding system or turn and till system of exterior and/or interior openings, this protection frame with the possibility of being removable, without changing the original design of the system's interior view. The magnetic fixing makes it easy to put on and take off. Furthermore, the profile used guarantees sufficient inertia, allowing dimensions of 1300×3000 mm (Width×Height) (W×H), considered large frames.

In this type of frame, it must be ensured that the visible frame of the protective frame is minimalist, that the perimeter is large and, additionally, that it has the capacity to adhere or fit to the existing framing in a robust and effective way, not allowing the It can be easily removed and could cause damage if it moves unintentionally.

This type of problem in frames with dimensions as large as 1300×3000 mm (WxH) is challenging, as in addition to its effective fixation, it is essential that its removal is also provided in a way that is accessible to the user, allowing the user to place the protective frame if desired and when you don't want it, you can remove it and store it or even remove it for cleaning.

The present invention uses magnetic elements distributed along the entire perimeter frame of the protection frame, including in the corners, these magnetic elements are individual magnets, and not strips or bands, the magnetic elements being elements with a high magnetic component, which allows the entire structure of the protective frame has adhesion to the fixed frame of the window or door, ensuring that the job site rough opening, or window/door frame, or spans can be reached (up to 1300×3000 mm).

Additionally, two types of squares are applied to the corners of the protection frame and said squares are embedded in the perimeter frame (1): fixing squares (3) reinforcing the structure and promoting the use of any type of material such as aluminium and alignment squares (5) ensures that the perimeter frame does not move. In this way, the use of lighter materials as material for the perimeter frame is also promoted, thus increasing the size of the spans. We have also ensured that the structure does not warp at the corners, causing it to “detach” from the fixed frame.

In addition to the solved problems indicated above, with the present invention it is not necessary to change the fixed frame of the window/door, but there is only a need to place magnets on that fixed frame. This allows the protection frame object of the present invention to be easily applied to any frames in use.

The present invention solves these problems by having a perimeter frame (1), this perimeter frame (1) comprising a profile that has two parts, the magnetic one, and the one that incorporates the desired protective panel (6). The magnetic part has a plurality of magnetic means (2) embedded inside and it adheres by magnetism to the fixed frame (8) of the window or door frame, fixed frame (8) means the part of the frame that is fixed to the building that has the window or door, and the part that incorporates the protective frame is superimposed on the perimeter frame (7) of vent (9), but does not come into contact with it, avoiding damage due to friction between that part of the perimeter frame (1) of the protection frame and the perimeter frame (7) of the vent (9).

It should be noted that in addition to all the particularities mentioned above, we also have to:
the protective panel to be placed on the protection frame can be whatever the user desires, in particular a mosquito net, an external light protection screen, a screen that prevents nighttime visibility into the interior of buildings, a radiation protection screen ultraviolet (UV), any type of screen can be used, including advertising screens, which in a commercial environment can protect against pollution of any type and also serve informative purposes;
there is no change to the original design of the framing system, which is of extreme advantage, since all the technology is hidden, without changing the aesthetics. The user can easily place and remove the protective frame whenever you want, without changing the design of the frame, as it is light.

### DESCRIPTION OF FIGURES

FIG. 1—representation of horizontal section/cut of profile of the present invention, this cut located in a part of a corner, where it is possible to observe in the profile of the perimeter frame (1) of the protection frame: in the part that does not come into contact with any surface, the protective panel (6) to be placed, the fixing squares (3) and the seal (4) of said protective panel; in the part that is fixed by magnetic means (2), the alignment square (5).

FIG. 2—representation of a preferred embodiment of width of the profile perimeter frame (1), in horizontal cut, and with 53 mm wide.

FIG. 3—representation of vertical section/cut of profile of the present invention section, this cut located in a part of a corner, where it is possible to observe in the profile of the perimeter frame (1) of the protection frame: in the part that does not come into contact with any surface, the protective panel (6) to be placed, the fixing square (3) and the seal (4) of said protective panel; in the part that is fixed by magnetic means (2), the alignment square (5). Through this figure and FIG. 1 it can be concluded that preferably the magnetic elements (2) are quadrangular in shape.

FIG. 4—representation of horizontal section/cut of profile of the present invention, this cut located at the bottom or top of the protection frame, and in this way it is possible to observe two corners and their components in the profile of the perimeter frame (1) of the protection frame: in the parts that do not come into contact with any surface, the protective panels (6) to be placed, the fixing squares (3) and the seals (4); in the parts that are fixed by magnetic means (2), the alignment square (5).

FIG. 5—representation of horizontal section/cut of a frame system in this case where the fixed frame (8) can be seen, which will be fixed to a building, with which comes into contact with the perimetral frame (1) of the protection frame object of present invention; and the perimeter frame (7) of the vent (9), in this case the vent being made of double glass, and on which part of the perimeter frame (1) of the protective frame object of the present invention which has the fixing square (3) and the seal (4) of said protective panel overlaps without contact. Note that this represents the placement of the protection frame on the interior side of the building.

FIG. 6—representation of horizontal section/cut of profile of the present invention, this cut located in any position other than a corner, where the protective panel (6), the seal (4), magnetic element (2), but not the fixing square (3), nor the alignment squares (5) since they are only found in the corners of the invention.

FIG. 7—Representation identical to FIG. 6, but here in technical lines.

FIGS. 8 and 9—Total representation of the invention, in final form and from the side that is visible when placed in a window or door, seeing only the perimeter frame (1) of the protection frame and its protective panel (6).

FIG. 10—Schematic representation of the placement of the magnetic elements (2) on the perimeter frame (1) of the protection frame and here it is clear that they are made up of the magnet (2a) and a cover (2b). The image on the left shows the sliding of the magnetic element (2a) to the desired location; In the central image, the lid (2b) is fixed to the perimeter frame (1) and the lid (2b) slides over the magnet (2a), as shown in the image on the right.

FIG. 11—Total representation of the invention, in final mode and on the side that is magnetically fixed to the fixed frame of the frame system, and as such it is possible to observe the perimeter frame (1) of the protection frame, the magnetic elements (2) distributed throughout the perimeter of the perimeter frame (1), the fixing squares (3) and alignment squares (5). Here it is clear that the fixing squares are not in the same part of the perimeter frame (1) as the magnetic elements (2). In this representation there is no protective panel in place.

FIG. 12—Isolated representation of a fixing square (3).

FIG. 13—detailed representation of a corner of the protection frame showing the fixing square (3) and the alignment square (5) and the magnetic elements (2) on the perimeter frame (1) of the protection frame.

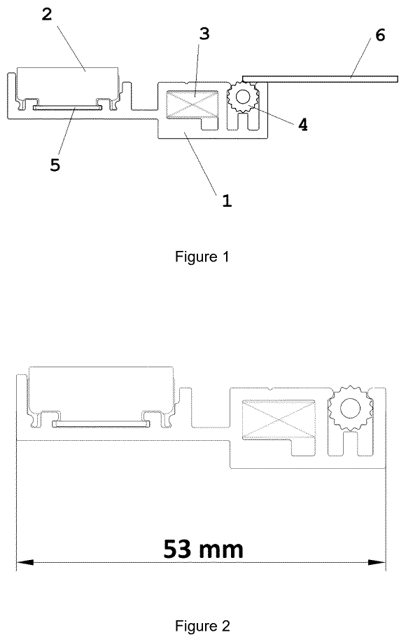

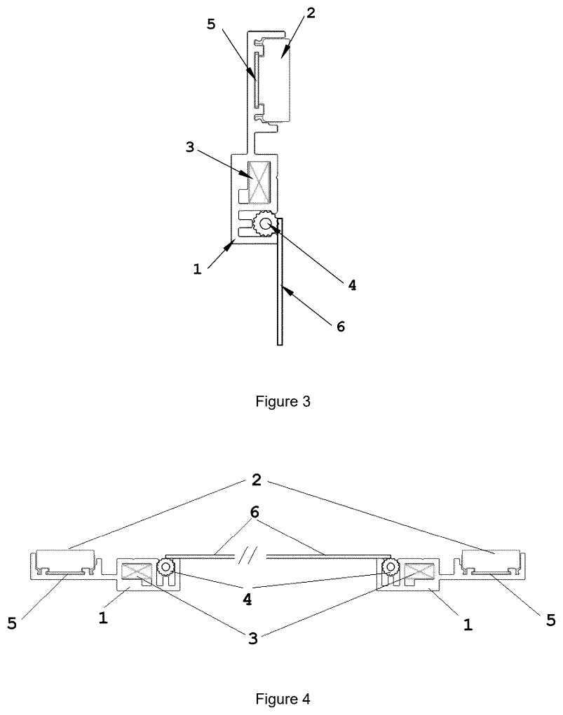

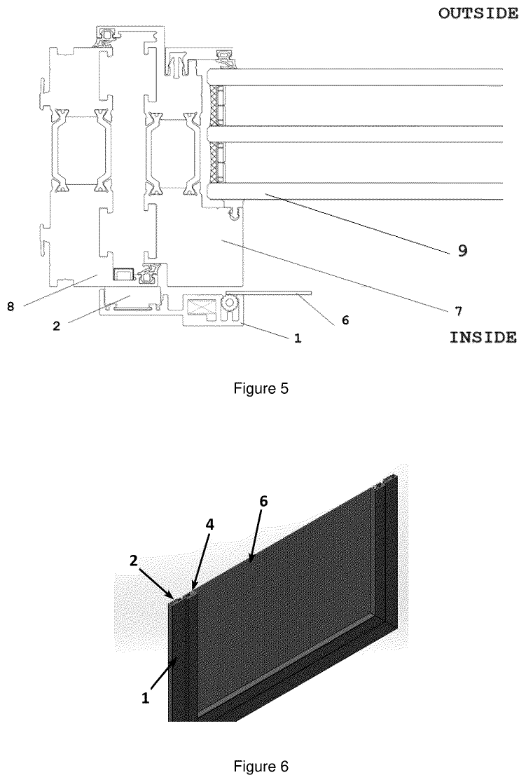

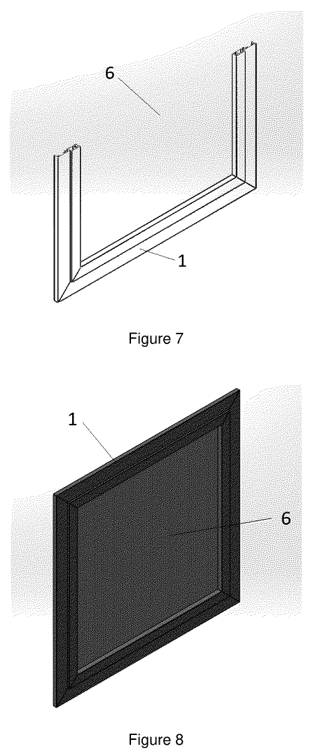

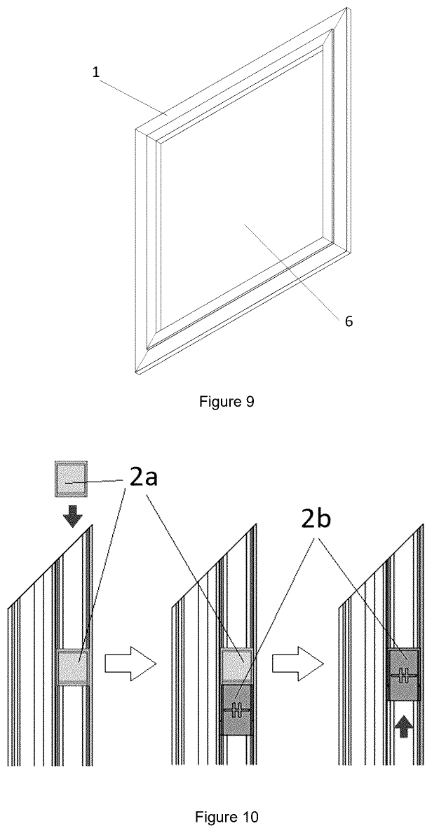

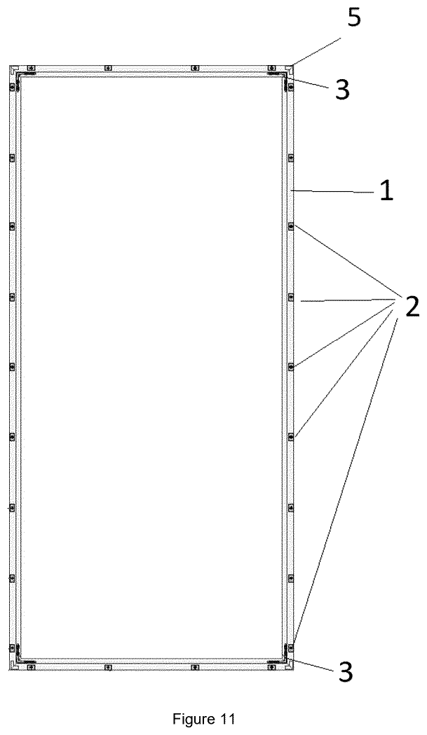

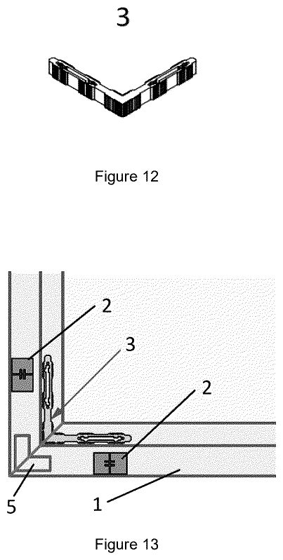

### DETAILED DESCRIPTION

The present invention concerns a protective frame for large frames, this protective frame to minimize pollution inside buildings through the placement of protective panels of specific types.

Frame should be understood as the set of a fixed frame (8) and at least one vent (9), this vent having a perimeter frame (7); and by fixed frame (8) the part of the frame that is fixed to the building that has the window or door.

The present invention comprises a perimeter frame (1) that surrounds, instead of a common glass, a protective panel (6). This perimeter frame (1) has two parts:
a magnetic part, which has a plurality of magnetic means (2) embedded inside of it and which adheres by magnetism to the fixed frame (8) of the window or door frame;
a non-magnetic part that incorporates the desired protective panel (6), this part is superimposed on the perimeter frame (7) of a vent (9), but does not come into contact with it, avoiding damage due to friction between that part of the perimeter frame (1) of the protection frame and the perimeter frame (7) of the vent (9).

To make it possible for the perimeter frame (1) to have a part that contacts the fixed frame (8) and another part that does not contact the perimeter frame (7) of the vent (9), between the two magnetic and non-magnetic parts there is a difference in level, an unevenness, this difference is high enough to overlap the perimeter frame (7) of a vent (9) but without contact.

The perimeter frame (1) has fixing squares (3), located at the corners of the perimeter frame (1) and in the non-magnetic part. These fixing squares (3) have corner geometry and have the function of reinforcing the structure so that the corners do not bend or move from the vertical axis of the protection frame, in this way the structure is reinforced and promotes the use of any type of material such as aluminium, lighter materials, which can therefore increase the size of the spans. We have also to ensured that the structure does not warp at the corners, causing it to “detach” from the fixed frame.

The perimeter frame (1) has alignment squares (5), located in the corners of the perimeter frame (1) and in the magnetic part, these alignment squares (5) promote greater perimeter reinforcement and that the perimeter frame (1) does not have any type of displacement in its use, since it is an object with some movement when placed in and removed from a window or door.

The perimeter frame (1) has magnetic means (2) located throughout the perimeter of the magnetic part. These magnetic means are made up of a magnet (2a) and a cover (2b) and are placed on the perimeter frame (1) by sliding prior to machining the protection frame, with the magnet sliding first (2a) to the desired location, attach the cover (2b) to the perimeter frame (1) and by sliding the cover (2b) covers the magnet (2a).

The protective frame can be placed on the inside or outside of the building, with the fixed frame (8) of the frame being magnetized by means known in the art.

The present invention may additionally include to the protection frame a set of magnetic elements (2a) to be fixed to the fixed frame (8), polarized to attach to the magnetic means embedded in the perimeter frame (1).

In a preferred embodiment of the invention, the protective panel (6) is a mosquito net, a screen that protects against external light, a screen that prevents nighttime visibility into buildings, a screen that protects against ultraviolet radiation (UV) or advertising screens.

The spacing between magnetic elements (2) must be a maximum of 350 mm in order to guarantee effective fixation. The magnetic elements (2) placed in the corners must have a distance from the apex/vertex of the respective corner between 90 mm and 110 mm, preferably 100 mm.

In a preferred embodiment of the invention, the perimeter frame (1) is preferably made of aluminium, a metal that provides greater resistance and durability to the frame, offers excellent water and air sealing, is light, easy to transport and install.

In a preferred embodiment of the invention, the perimeter frame (1), so that its placement is possible and its overlap with the perimeter frame (7) of the vent (9) is effective, preferably has a width between 5 mm and 6 mm, even more preferably 53 mm.

In a preferred embodiment of the invention, the magnetic elements (2) are neodymium magnets, which guarantees them extreme traction force.

In a preferred embodiment of the invention, the magnetic elements (2) are quadrangular in shape.

It should be noted that with the present invention it is not necessary to change the fixed frame system frame, but there is only a need to place magnets on the fixed frame, that is, it is sufficient, for example, to place magnets inside a flap of the fixed frame.

Additionally, it is noted that the present invention additionally presents means to make its placement and removal possible, such as handles, or recesses, or equivalent, included in the perimeter frame of the protection.

As will be evident to one skilled in the art, the present invention should not be limited to the embodiments described in the present document, with several modifications being possible that remain within the scope of the present invention. Evidently, the preferred modes presented above are combinable, in the different possible ways, avoiding the repetition of all these combinations.

1. Protection frame for large frames comprising a protective panel (6), said protective panel (6) comprising around entire perimeter a perimeter frame (1), said perimeter frame (1) comprising:
a) a magnetic part comprising a plurality of magnetic means (2) embedded inside and adhering by magnetism to a fixed frame (8) of a window or door frame; a non-magnetic part incorporating the protective panel (6) and being superimposed without contact on a perimeter frame (7) of a vent (9); and an unevenness between both magnetic and non-magnetic parts, said unevenness higher enough to overlap the perimeter frame (7) of the vent (9) without contact;
b) fixing squares (3) located at the corners of the perimeter frame (1) and at the non-magnetic part;
c) alignment squares (5), located at the corners of the perimeter frame (1) and at the magnetic part; It is
d) magnetic means (2) located throughout the perimeter of the magnetic part.

2. Frame according to claim 1 wherein the fixing squares (3) have corner geometry.

3. Frame according to claim 1 wherein the magnetic means (2) comprising a magnet (2a) and a cover (2b).

4. Frame according to claim 1 wherein the magnetic elements (2) are neodymium magnets.

5. Frame according to claim 1 wherein the magnetic elements (2) are of quadrangular in shape.

6. Frame according to claim 1 wherein the spacing between magnetic elements (2) is a maximum of 350 mm.

7. Frame according to claim 1 wherein the magnetic elements (2) are located at the corners of the perimeter frame (1) and have a distance from the apex of the respective corner between 90 mm and 110 mm.

8. Frame according to claim 1 wherein the magnetic elements (2) are located at the corners of the perimeter frame (1) and have a distance from the apex of the respective corner of 100 mm.

9. Frame according to claim 1 wherein the protective panel (6) is a mosquito net, an external light protection screen, a screen that prevents nighttime visibility into the interior of buildings, an ultraviolet radiation (UV) protection screen and/or an advertising screen.

10. Frame according to claim 1 wherein the perimeter frame (1) is made of aluminium.

11. Frame according to claim 1 wherein the perimeter frame (1) has a width between 5 mm and 6 mm.

12. Frame according to claim 1 wherein the perimeter frame (1) has a width of 53 mm.

13. Frame according to claim 1 wherein the perimeter frame (1) comprises embedded at least one handle or recesses.

14. A protection kit for large frames comprising a protection frame described in claim 1 and a set of magnetic elements (2) to be fixed to at least a fixed frame (8) of a frame, in such a way that the fixed frame (8) is fixed to the protection frame using magnetic means (2) embedded in the perimeter frame (1) of the protection frame.

15. The protection kit of claim 14, where the fixing squares (3) have corner geometry.

16. The protection kit of claim 14, where the magnetic means (2) comprising a magnet (2a) and a cover (2b).

17. The protection kit of claim 14, where the magnetic elements (2) are neodymium magnets.

18. The protection kit of claim 14, where the magnetic elements (2) are of quadrangular in shape.

19. The protection kit of claim 14, where the spacing between magnetic elements (2) is a maximum of 350 mm.

20. The protection kit of claim 14, where the magnetic elements (2) are located at the corners of the perimeter frame (1) and have a distance from the apex of the respective corner between 90 mm and 110 mm.

21. The protection kit of claim 14, where magnetic elements (2) are located at the corners of the perimeter frame (1) and have a distance from the apex of the respective corner of 100 mm.

22. The protection kit of claim 14, where the protective panel (6) is a mosquito net, an external light protection screen, a screen that prevents nighttime visibility into the interior of buildings, an ultraviolet radiation (UV) protection screen and/or an advertising screen.

23. The protection kit of claim 14, where the perimeter frame (1) is made of aluminium.

24. The protection kit of claim 14, where the perimeter frame (1) has a width between 5 mm and 6 mm.

25. The protection kit of claim 14, where perimeter frame (1) has a width of 53 mm.

26. The protection kit of claim 14, where the perimeter frame (1) comprises embedded at least one handle or recesses.
